(19) United States
(12) Patent Application Publication
(10) Pub. No.: US 2002/0087394 A1
(43) Pub. Date: Jul. 4, 2002

(54) Digital security election system with digitalized ballot, vote stamp and precision tallying devices, and method therefore

(76) Inventor: Franklin Zhigang Zhang, Torrance, CA (US)

Correspondence Address: Franklin Zhigang Zhang, 4808 Laurette Street, Torrance, CA, 90503, US

(21) Appl. No.: 10/040,145

(22) Filed: Jan. 2, 2002

Related U.S. Application Data
(60) Provisional application No. 60/259,500, filed on Jan. 3, 2001.

(51) Int. Cl. G06F 17/60

(52) U.S. Cl. 705/12

(57) ABSTRACT

A method and system is provided to improve election with easy use, security, and accuracy. Voters use vote stamp to vote on ballot. The ballot with a vote stamp design not only provides voters very clear and easy use way to vote, but also the standardized vote stamp greatly improve the tally accuracy. The digital encrypted start code on the ballot provides both pre-vote validity check of the ballot and the validity check of the tally system. Computerized tally system comprises multiple tally units can tally the regular ballot accurately and efficiently, while the non-regular voted ballot, bad ballots, illegal ballots are sorted out for further process. The counted record on the ballot helps the system to identify the ballots, which are already counted. Graphic identification system comprises multiple graphic identification units, can process the non-regular voted ballots and find out the exact intend of the voters.

### CROSS-REFERENCE TO RELATED APPLICATIONS

This application claims the benefit of the Provisional Patent Application Ser. No. 60/259,500 filed Jan. 3, 2001.

### BACKGROUND

1. Field of Invention

The present invention relates to an election system. More particularly, to a voting system and method, which uses vote stamps for electors to check the candidates on the ballot whom they want to vote, and, the corresponding precision tally devices and digital security system to get the result of the election.

2. Description of Prior Art

It is known that when election in a small group, votes are easy to count, the willing of the voters are easy to be precisely found out. However, when voter number reaches a high volume, because of the diversity of the people, and difficulty of the organization and operation, it is always very difficult to find out the willing of the voters precisely, especially when there are political unfairness or evil force try to misinterpret the willing of the voters. The collection and tallying of votes during an election can be a monumental task. In particular, the election of government officials encompasses possibly millions of voters. There were many arts invented to meet the requirements of the election activities, including: electronic ballot, paper ballot, and many different ballot-collecting devices. Most of them are using “punch holes” and “darken bobbles” method for voters to select the candidates they like. But voters who do not punch ballot through the hole and/or the bobbles are not darken enough for tally device to identify always affect the accuracy of the tallying result. Manual mal-operation and/or fraud cannot be prevented because lack of enough security protection on the ballot and the tallying process.

In order to find out the real willing of the public in different situation, in the prior arts different ballots and counting methods including equipments are adopted. But most of them have difficulties to guarantee the fairness and efficiency.

So an election system must be designed in a complete consideration of the voter, the ballot, and the tally. All the involvements must be designed to ensure a fair election process efficiently.

### SUMMARY

The present invention efficiently achieves a secure election with precise result, cost effective and easy use, by the special designed system, which comprises: digitalized ballot and vote stamp; computerized tally system, and graphic identification system.

The special designed ballot with digital security and vote stamp ensure not only the valid ballots can be precisely counted, but also easy use and low cost. Digital encrypted security identification ballot design and regarding counting function of the system prevent ballot fraud. The vote stamp not only provides an easy method to vote, but also greatly improves the tally accuracy and efficiency. The digital security code on the ballot provides a possibility for voters to check the validity of the ballot they received before vote so that to protect the pre-vote mal-operation and fraud.

Computerized tally system comprises multiple tally units, which are linked together by LAN, provides very flexible scalability to be configured to different size of election. The tally system can also prevent the manual operation errors, such as the machine operator may place the wrong ballots in to the system, or duplicate or the ballots have been already counted.

Graphic identification system comprises multiple graphic identification units. Graphic identification unit can identify the ballots, which are not voted according to instructions, or the way some voter's vote cannot be clearly identified by the tally system. The graphic identification system can find out the exact willing of the voters by checking the symbols made by voters on ballot. There's no manual involvement required, thus the system can provide efficiently fairness without human errors. Both the tally system and graphic identification system are linked to data center server and database via LAN.

### OBJECTS AND ADVANTAGES

Accordingly, several objects and advantages of my invention are:

1. to prevent manual error during election by using vote stamp to vote on the ballot;

2. to provide secure election system with precise result, cost effective, easy use and high efficiency;

3. to provide the digital security ballot with encrypted barcode and the standardize self-adhesive vote stamp thus to ensure the precision, efficiency to the tallying process and convenience to voters;

4. to provide pre-vote ballot validity verification for voters via Internet and/or phone and/or the vote station to check the validity of the ballot they received so that to prevent the pre-vote mal-operation and fraud;

4. to provide computerized tally system which can count and distribute ballots into different types of ballot collector automatically, thus to prevent the manual operation errors;

5. to provide graphic identification system which can analyze and process the symbols made by the voters on the ballot, thus to know the exact willing of the voters and provide efficiently fairness without human errors.

The forgoing features and advantages of the present invention can be appreciated more fully from the following description, with references to the accompanying drawings in which.

### BRIEF DESCRIPTION OF THE DRAWINGS

FIG. 1 is a function block diagram showing the precise voting system with the present invention.

FIG. 2 is the block diagram of a tally unit and graphic identification unit of the present invention.

FIG. 3A shows a sample ballot design with current invention.

FIG. 3B shows a sample vote stamp sheet design with current invention.

FIG. 4 shows the process of the pre-vote security check with current invention.

FIG. 5 is the tallying operation flowchart of the present invention.

FIG. 6 is the flowchart of the operation of the tally unit of the present invention.

FIG. 7 is the flowchart of the operation of the graphic identification unit of the present invention.

### DESCRIPTION

Preferred Embodiment

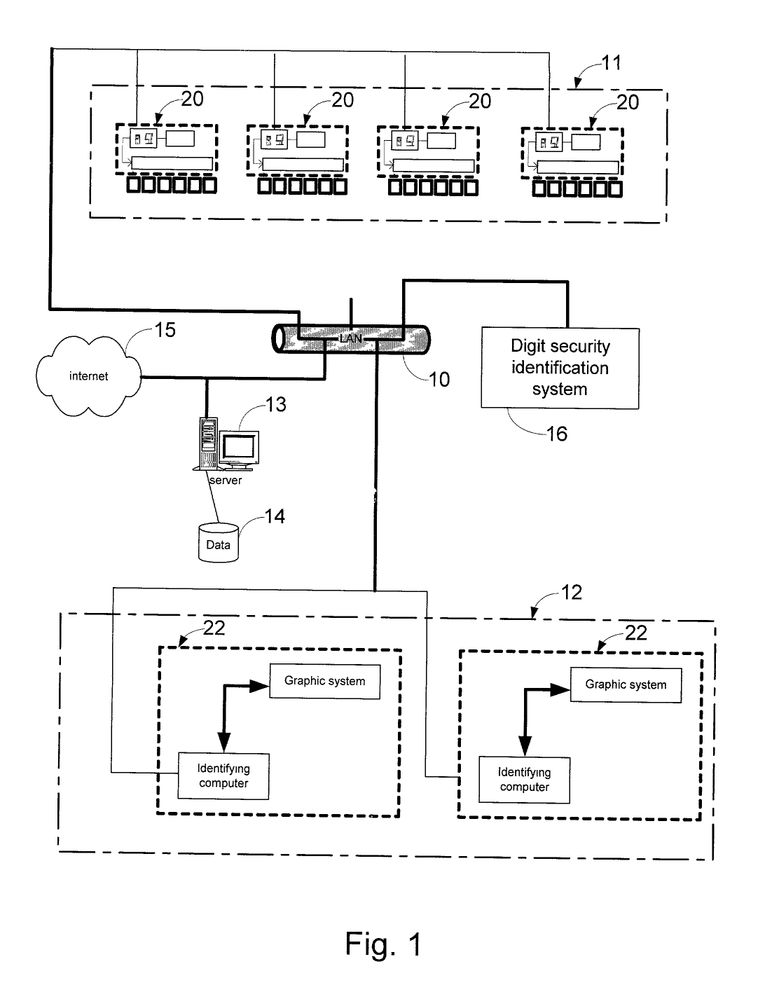

FIG. 1 is a function block diagram showing the precise voting system with the present invention. As shown, the precise voting system comprises computerized tally system 11; graphic identification system 12; data center server 13, database 14, and digital security identification system 16. The computerized tally system 11 comprises multiple tally units 20 which are linked to data center server 13 and database 14 via LAN 10. The graphic identification system 12 comprises multiple graphic identification units 22 which are linked to data center server 13 and database 14 via LAN 10. The data center sever 13 and database 14 is used to carry on all the election data activities of the election. All of the counting results achieved by both tally system 11 and graphic identification system 12 and final reports are stored and printed in/by the data center sever 13 and database 14.

Digital security identification system 16 is linked to data center server 13 and database 14 as well as internet to provide local pre-vote identification of the voter and ballot, and online or telephone pre-vote identification of ballot.

All the devices connected to the LAN may be provided with the internet connectivity to perform the remote data exchange.

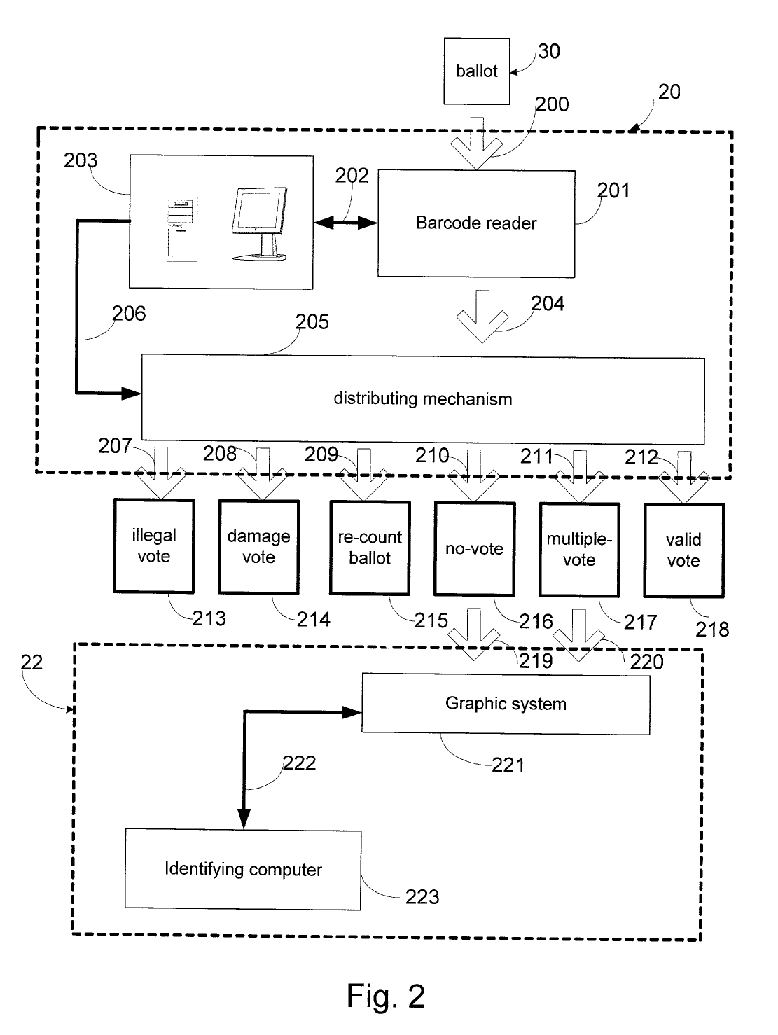

FIG. 2 is the function block diagram of a tally unit and graphic identification unit of the present invention. After vote, every ballot is collected and sent to one of the tally unit 20. The tally units count and distribute all the ballots into different types of ballot collector accordingly. The tally unit 20 comprises barcode scanner 201, computer system 203, distributing mechanism unit 205 and after-count ballots processing units: illegal vote processing unit 213 handles the illegal ballots distributed by the distributing mechanism unit 205; damage vote processing unit 214 handles the damage ballots by the distributing mechanism unit 205; re-count ballot processing unit 215 handles the ballots identified by the tally system 20 that has already been counted; no-vote processing unit 216 handles the ballots identified by the tally system 20 as no vote; multiple-vote processing unit 217 handles the ballots identifies by the tally system 20 as multiple vote; valid vote processing unit 218 handles the ballots identified by the tally system 20 as valid vote. Once a ballot is identified as valid vote, it will be recorded with the counted message. If the counted ballot enters any of the tally units again, the tally unit can recognize it from the counted message and the ballot will not be counted. Thus, the mal-operation is prevented.

No-vote ballots and multiple-vote ballots are handed over to one of the graphic identification units 22 of the graphic identification system 12. These ballots are scanned into the graphic identifying computer 223 by the graphic input system 221. The graphic identifying computer analyzes and processes these ballots. All of the counting results are stored in the database.

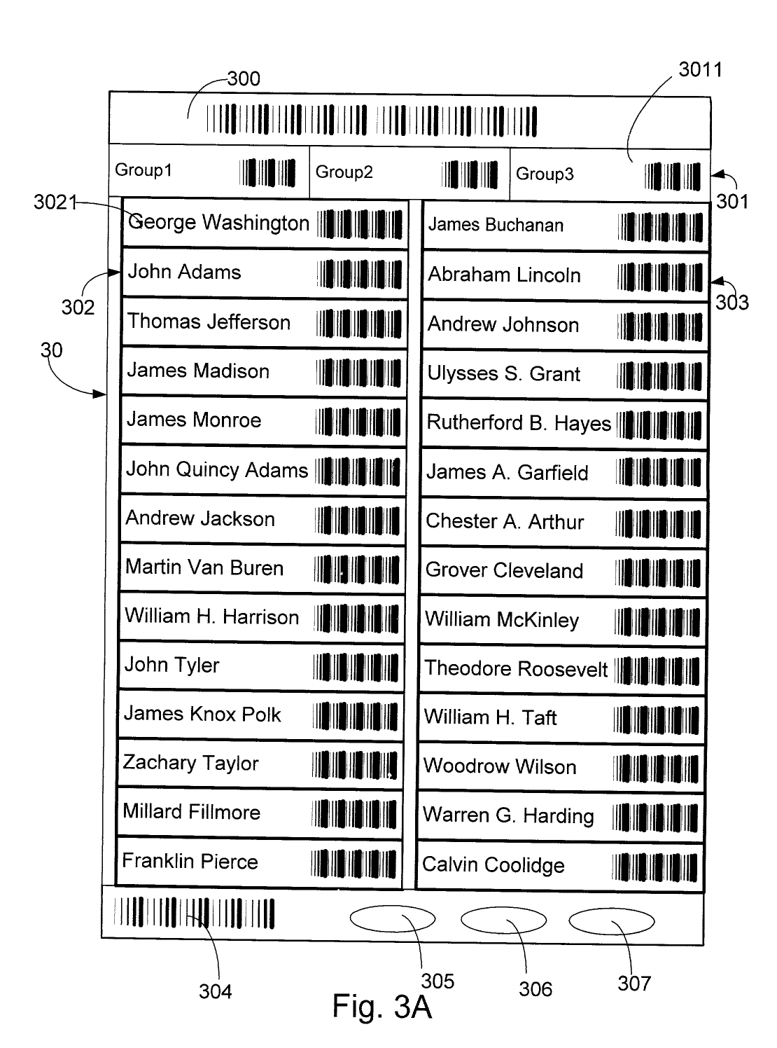

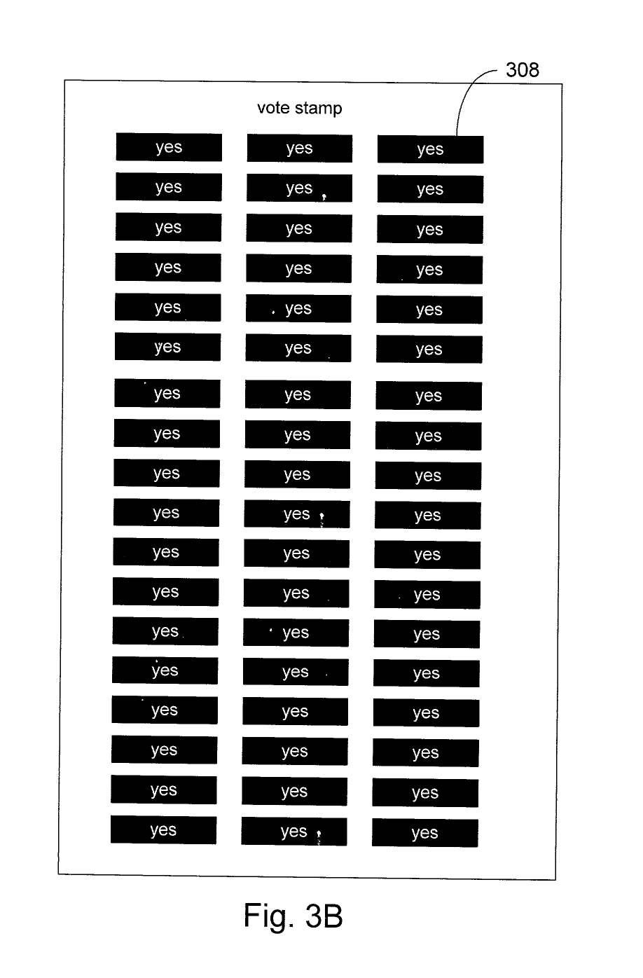

FIG. 3A shows a sample ballot design with current invention. In order to clearly find out the willing of the voters, the ballot needs to be designed to work with the tally system, while maintains effectively cost and easy use, because of the mass volume and the variety of the voters. The ballot 30 of the present invention is designed made of cardboard paper or printable plastic. On the ballot 30, there is a starting zone 300 comprises digital security encrypted barcode. This zone 300 can notify the tally unit 20 it's the beginning message of a specific ballot and also provide the computer system 203 with digital encrypted security message of the ballot. The ballot 30 also comprises multiple vote messages zones, such a s group vote and different candidates. Different election can have different vote zone design. But specifically, each candidate and/or group name unit comprises the name and unique barcode message for the candidate or the group. The barcode is the vote area of the specific candidate and or group. A barcode covered by the vote stamp means the voter selects to vote for the candidate or the group. As shown in the embodiment, the sample ballot has a group vote zone 301, which comprises three groups. Group cell 3011 comprises name and the unique barcode for it. The barcode is the vote area for the group. Similarly, the sample ballot also has two candidates zone 302 and 303, which comprises many candidate cells. The candidate cell 3021 comprises name and the unique barcode for it. The barcode is the vote area for the candidate. The end barcode 304 provides the end message for the tally system. The count message areas 305, 306, and 307 are the area where the count message and/or re-count message can be printed.

FIG. 3B shows a sample vote stamp sheet design with current invention. To standardize the vote habit is the key to ensure the precision and efficiency of the tally process. The more manual variety provided during the vote, the more difficulty is created to the tally process. With the prior art of “darken bubbles” and “punch hole”, there are always problem created by “not dark enough” or “not punch through” or many other errors made by the voters. These errors cause a lot of problems at the tally process. In the past, a lot money and manpower were through in; there were still inaccuracy vote results. With present invention, the standardize vote stamp is introduced. When vote, voters can simply put the vote stamp on the barcode vote area for the candidates they want to vote in the ballot 30(FIG. 3A). The ballots voted by the vote stamp provide the tally system with extra high accuracy possibility. As shown in the embodiment, a vote stamp sheet comprises many/enough vote stamps 308 of the same size with the barcode vote area of the ballot. These stamps are self-adhesives.

Preferred Embodiment

Operation

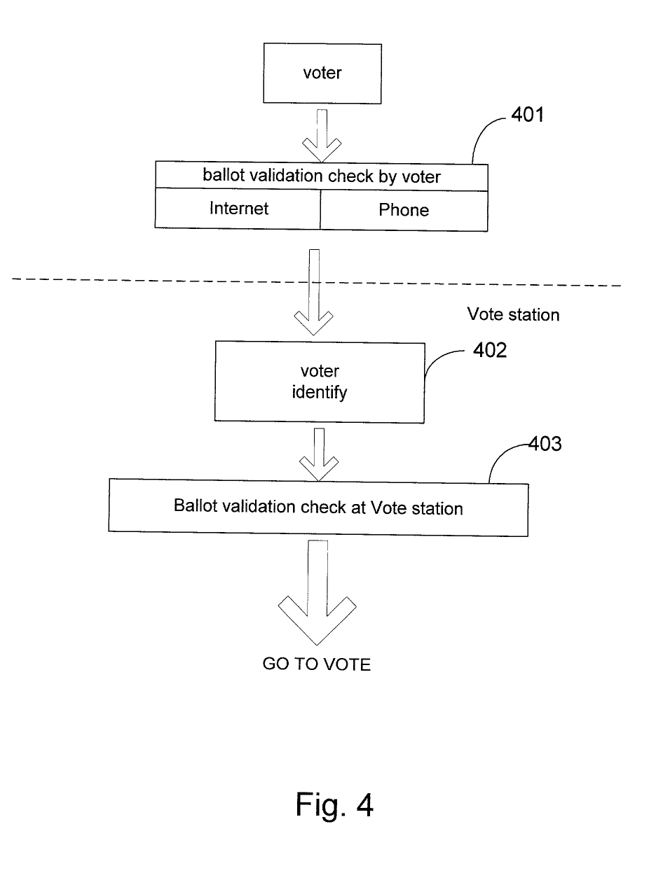

FIG. 4 shows the process of the pre-vote security check with current invention. By conventional method, there is a voter identification process before the vote to ensure the voter has the right to vote. With the digital security design of the present invention, it is now possible to do the pre-vote ballot validity verification. Voters can do the pre-vote ballot validity verification (step401) before they go to vote via Internet and/or phone. The vote station to ensure the ballot validity can also provide pre-vote ballot validity verification (step403).

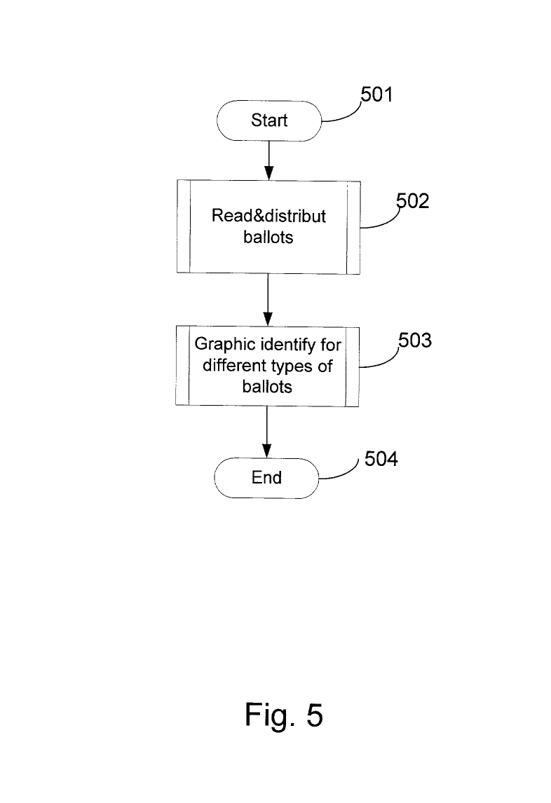

FIG. 5 is the tallying operation flowchart of present invention. The tallying process of present invention comprises the tallying operation and the graphic identification. Once the tallying process started (step501), all the ballots are sent to the tally system 11 for counting. The tally system reads and distributes the ballots (step502). After pass this process, all the ballots are distributed into different types of ballot collector. The ballots voted according to the vote instructions are identified as regular vote. The results of ballots with regular vote identified by the tally system are counted and reported to data center server 13 and database 14. The rest ballots are further processed. There are always some people do not follow the vote instructions for all kinds of reasons. A valid ballot, which is not voted according to the vote instructions, is identified as non-regular vote. The valid ballots with non-regular votes identified by the tally system are processed to find out the exact vote result (step503). The results of the non-regular ballots from the graphic identification are reported to data center server 13 and database 14. In combining with these two results, the accuracy result of the election can be achieved.

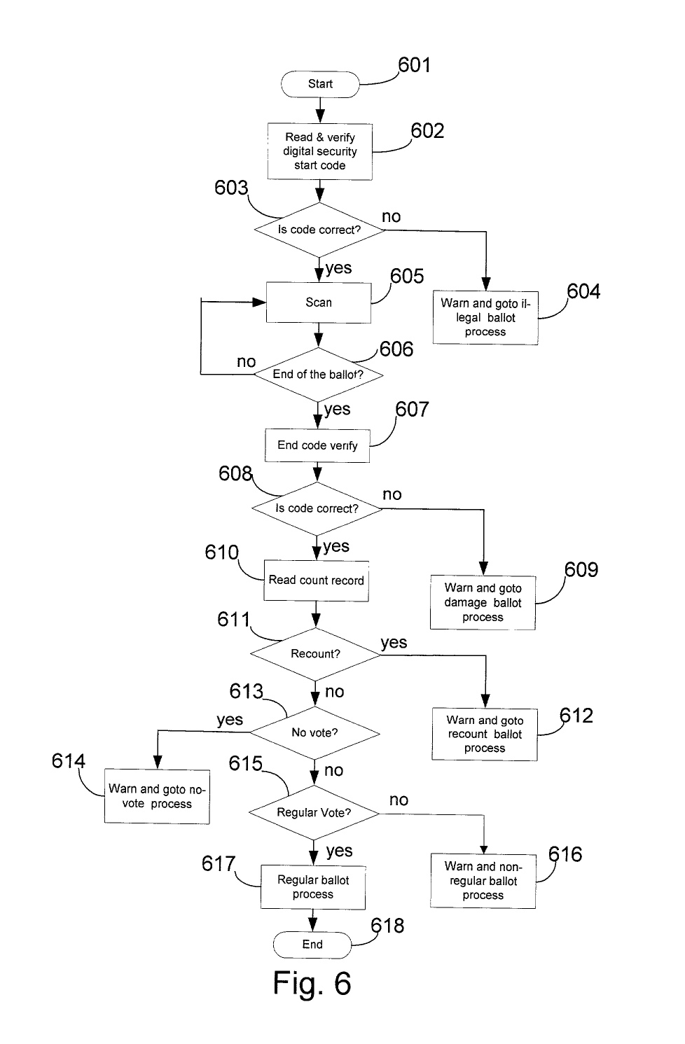

FIG. 6 is the flowchart of the operation of the tally unit. As shown, at the step 602 when a ballot enters tally unit, the tally unit first reads and verifies the digital security encrypted barcode on the starting zone. At the step 603 the tally unit checks if the barcode is correct? If the code is not found or the code is incorrect, the system warns the operator and sends the ballot to illegal ballot collector (step604). If the code is correct, at the step 605,606 the system scans all the vote information on the vote messages zones of the ballot, and also checks if there is an end barcode at the step607, 608. If the end barcode is not present, it means this is a damage ballot; the system warns the operator and sends it to the damage ballot collector (step609). If the normal end code is found, at the step610 the system checks if there is any counted record on the count message areas of the ballot. If an counted record is found, it means that for some reasons the ballot was sent to the tally system by mistake, the system warns the operator and sends the ballot to the re-count ballot collector (step612). If no counted message is found, at the step613 the system checks if there is any vote message on the ballot. If there is no vote message shown up, it means maybe the ballot was not voted according to the instruction, further identification need to be taken place, the system warn the operator and send it to no-vote collector (step614). If there are vote messages found on the ballot, at the step615 system checks if it is a valid voted ballot according to the vote instruction? If yes, the system records the vote message, prints the count message on the count message areas of the ballot, and sends it to regular vote collector (step617). If not, the system warns the operator and sends the ballot to the non-regular voted ballot collector for further identification (step616).

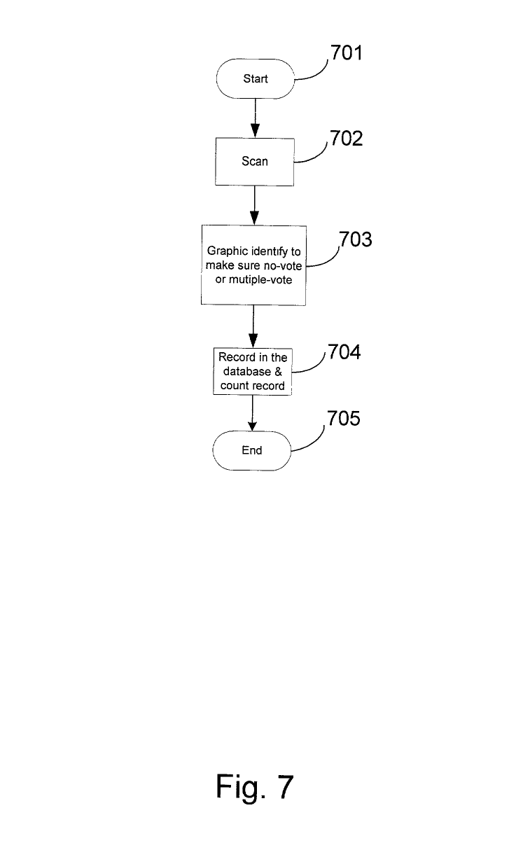

FIG. 7 is the flowchart of the operation of the graphic identification unit of present invention. As shown, at the step702 the system scans the whole image of the non-regular voted ballot. The specific designed software can identify the vote message on the ballot (step703). Then at the step704 the system processes the ballot according to the election rule. The voter intends can be clearly found out by the system. For example, for some reason, the voter did not use the vote stamp to vote, he marked the candidates he wanted to vote by pen. The tally units cannot identify the marks. By the software, the graphic system can still identify the marks, if the voter met the rest rule of the election, the ballot can still be a valid ballot, the vote message can be processed like a regular ballot.

Conclusion, Ramifications, and Scope

It can be seen that, I have provided the digital security election system with precise result, cost effective, easily use and high efficiency. The paper ballot with barcode vote stamp standardizes the voting process. Voters with different age, education and other background can precisely and easily understand it. This greatly eliminates the confusion caused by the voting method of other prior art by using punch hole or darken bobbles, because two darken bobbles can never be exactly the same dark even drawn by the same people; or punched holes could not be exactly the same. The vote stamp of current invention with barcode printed is a digitized stamp, so the vote will be the same no matter who use it to vote. The vote message can be very clear. The ballot also is combined with digital security features to allow to secure the ballot itself.

The election system comprises the tally system, graphic identification system, data center server, database, digital security identification system for pre-vote ballot valid identification, digitalized ballot and vote stamp. Current invention combines digital technology with paper ballot perfectly.

Furthermore, the whole system has additional advantages in that:

1) The tally system and the graphic identification system provide very flexible scalability to be configured to different size for election according to the system comprising how many tally units and graphic identification units.

2) Paper print ballot has many advantages over full electronics system. It has a hard copy of original vote. Even if the computer system was broken in by hackers or system failure, it is still possible to get the correct result by recount the ballots.

3) Because of the tally unit processes and distributes every ballots into different types of ballot collector, Mal-operation is prevented.

4) The graphic identification unit further analyzes the non-regular voted ballot, bad ballots, illegal ballots etc., thus the current invention can double-check the ballot and guarantee the fairness without manual errors.

5) The standardized ballot with digital encrypted security message can be counted efficiently, precisely by the tally unit.

6) Self-adhesive vote stamp can be very easily, clearly used by the voters.

7) The digital encrypted start code on the ballot provides both pre-vote validity check of the ballot and the validity check of the tally system.

Although the description above contains much specificity, these should not be construed as limiting the scope of the invention but as merely providing illustrations of some of the presently preferred embodiments of this invention. Various other embodiments and ramifications are possible within it's scope. For example: The material of the ballot may not be paper; a printed plastic sheet can be used as a replacement. The vote stamp may be other material with capability to stick on the ballot and be printed with vote message. The barcode vote information can be printed on ballot voting zone or at vote stamp or both.

Thus the scope of the invention should be determined by the appended claims and their legal equivalents, rather than by the examples given.

What is claimed is:

1. An election system comprises the tally system, graphic identification system, data center server, database, digital security identification system, digitalized ballot and vote stamp.

2. The tally system of the claim 1 comprises multiple tally units which can be linked together by LAN or internet.

3. The tally unit of the claim2 comprises barcode reader, computer system, distributing mechanism unit and after-count ballots processing units.

4. The barcode reader of the claim3 can scan the ballots and read the barcode message on the ballot.

5. The distributing mechanism unit of the claim3 can sort the ballots into different types of ballot collectors automatically according the checking output result from the computer system of the claim3.

6. The after-count ballots processing units of the claim 3 may comprises illegal vote processing unit, damage vote processing unit, re-count ballot processing unit, no-vote processing unit, multiple-vote processing unit and valid vote processing unit.

7. The graphic identification system of the claim1 comprises multi graphic identification units which can be linked together by LAN or internet.

8. The graphic identification unit of the claim7 comprises graphic input system and graphic identifying computer.

9. The graphic input system of the claim8 can scan the non-regular ballots into the graphic identifying computer which further analyzes and processes these ballots.

10. The data center server and database of the claim1 store the counting result achieved by the tally system and graphic identification system.

11. The digital security identification system of the claim1 can be linked to the data center server and database to provide local vote station and/or online and/or telephone pre-vote identification for the validity of the voter and the ballot.

12. The ballot of the claim1 which has digital encrypted security barcode messages can be counted efficiently, precisely by the tally unit of claim 3 and used easily, clearly by the voter with the self-adhesive vote stamp of the claim1.

13. A method of ease and security election, comprises
pre-vote ballot and voter security identification;
voter voting by placing the vote stamp on to the ballot;
ballot tallying;
graphic identifying un-regular ballot if necessary.

14. A method of ballot graphic identification of claim 13, comprises
transferring un-regular ballots to the graphic identification system;
graphic identification system scanning every un-regular ballot completely;
identifying the scanned information by software means;
reporting the result of identification.
